(19) United States
(12) Patent Application Publication
(10) Pub. No.: US 2026/0349371 A1
(43) Pub. Date: Nov. 5, 2026

(54) POSITION OF TONER OUTLET FOR TONER CARTRIDGE

(71) Applicant: Hewlett-Packard Development Company, L.P., Spring, TX (US)

(72) Inventors: Junhui Kim, Seongnam-city, Gyeonggi-do (KR); Sanghoon Lee, Seongnam-city, Gyeonggi-do (KR); Jinsam Park, Seongnam-city, Gyeonggi-do (KR); Jongin Kim, Seongnam-city, Gyeonggi-do (KR)

(73) Assignee: Hewlett-Packard Development Company, L.P., Spring, TX (US)

(21) Appl. No.: 19/100,118

(22) PCT Filed: Feb. 15, 2023
(86) PCT No.: PCT/US2023/013168

§ 371 Date: Jan. 30, 2025

(30) Foreign Application Priority Data
Aug. 17, 2022 (KR) 10-2022-0102507

(51) Int. Cl. G03G 15/08

(52) U.S. Cl. CPC G03G 15/0877; G03G 15/0872; G03G 15/0889; G03G 15/0891; G03G 2215/0668; G03G 2215/0675

(57) ABSTRACT

An example toner cartridge includes a body having a toner outlet and a toner transport member having a spiral portion and installed in the body to transport toner to the toner outlet by being rotated. The toner outlet is positioned under a rotation center of the toner transport member in such a way as to be biased toward a downstream side in a rotation direction of the toner transport member. WO

### CROSS-REFERENCE TO RELATED PATENT APPLICATIONS

This application claims priority to South Korea Patent Application No. 10-2022-0102507, filed on Aug. 17, 2022 the entirety of which is incorporated by reference herein.

### BACKGROUND

A print apparatus using an electrophotographic method supplies toner to an electrostatic latent image formed on a photoconductor to form a visible toner image on the photoconductor, transfers the toner image through an intermediate transfer medium or directly to a print medium, and fuses the transferred toner image onto the print medium.

Toner may be contained in a toner cartridge and may be supplied from the toner cartridge to a developing device. Based on the toner contained in the toner cartridge being used up, the toner cartridge may be removed from a main body of the print apparatus and a new toner cartridge may be mounted on the main body.

### SUMMARY OF THE INVENTION

Various examples will be described below by referring to the following figures.

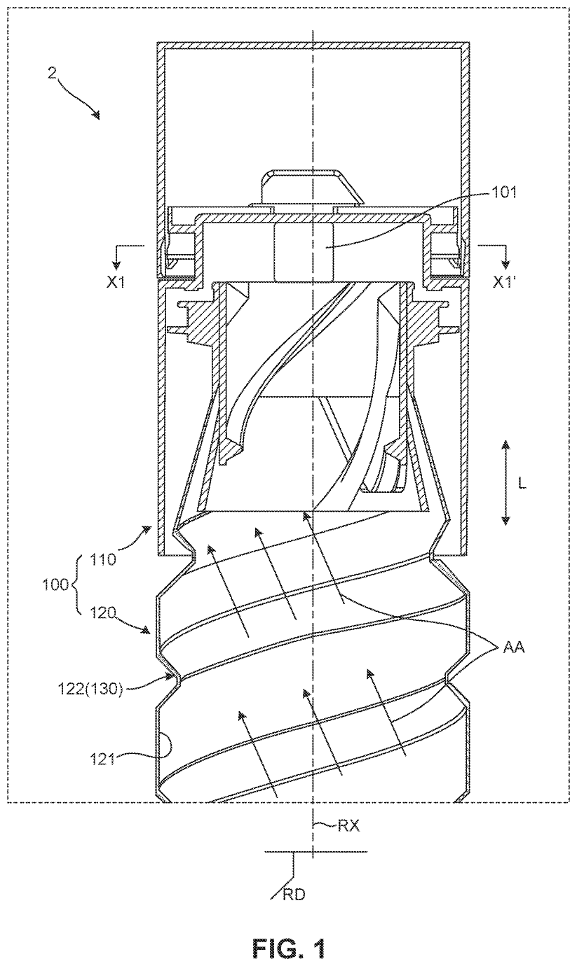

FIG. 1 is a schematic partial cross-sectional view of a toner cartridge according to an example;

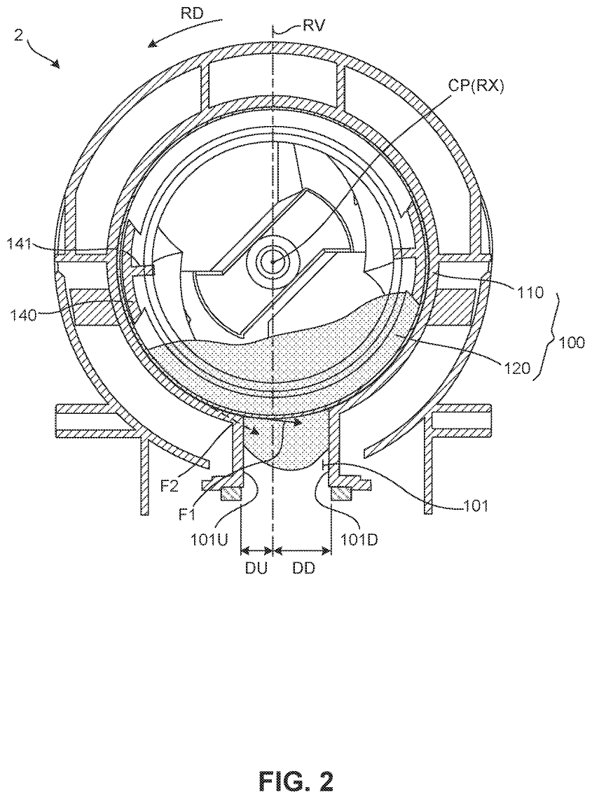

FIG. 2 is a cross-sectional view taken along X1-X1′ of FIG. 1 according to an example;

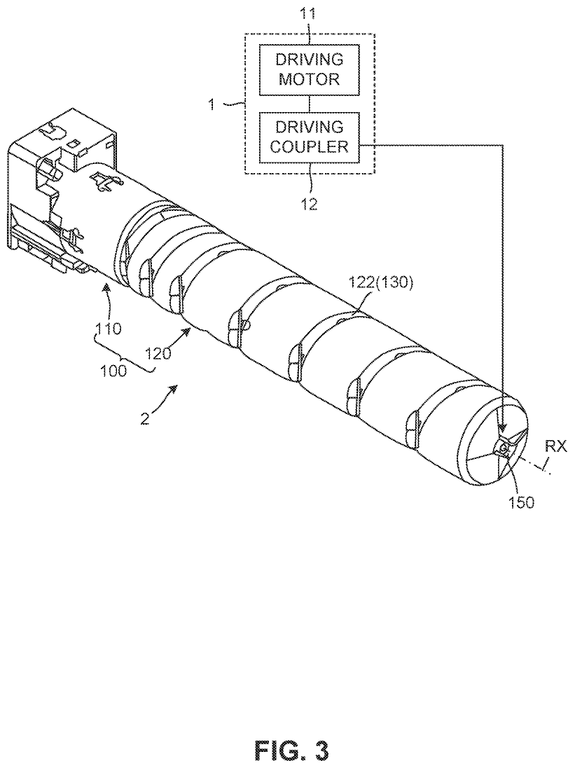

FIG. 3 is a schematic perspective view of a structure to rotate a rotation unit of a toner cartridge according to an example;

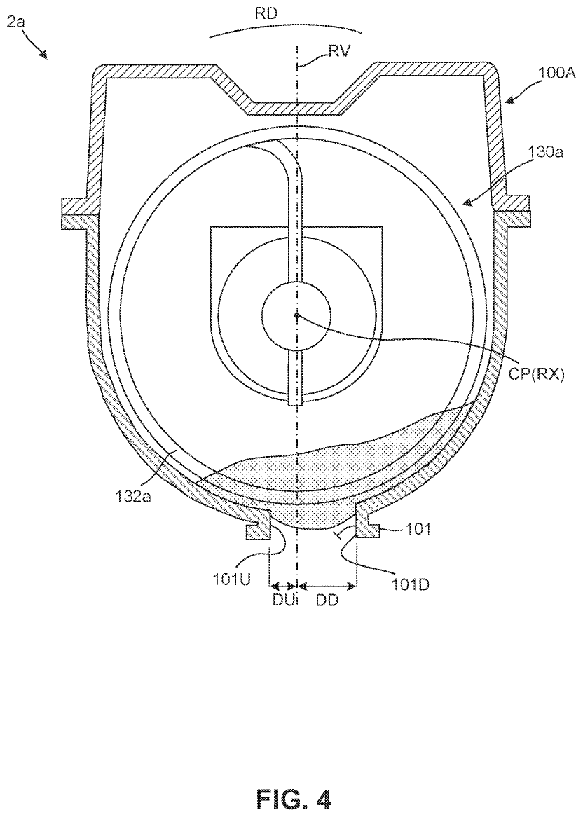

FIG. 4 is a schematic cross-sectional view of a toner cartridge according to an example;

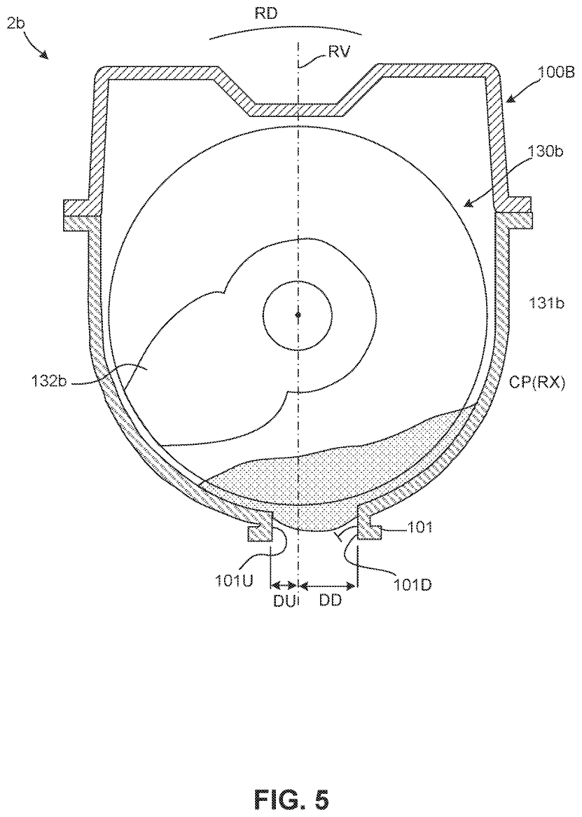

FIG. 5 is a schematic cross-sectional view of a toner cartridge according to an example;

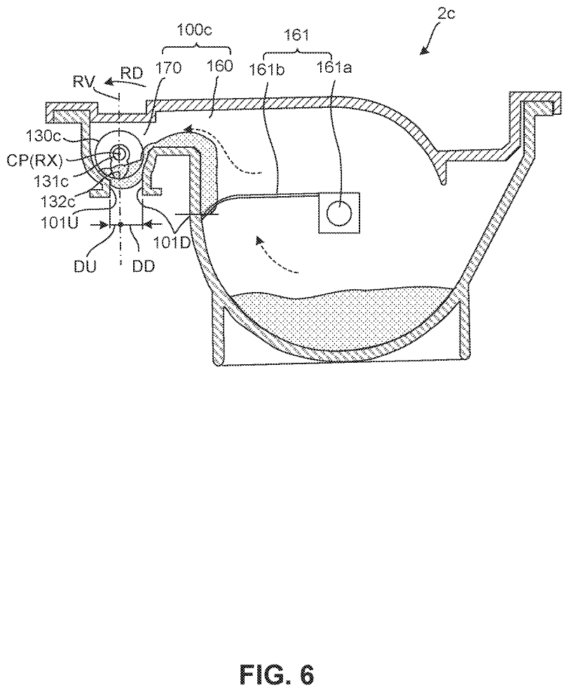

FIG. 6 is a schematic cross-sectional view of a toner cartridge according to an example; and

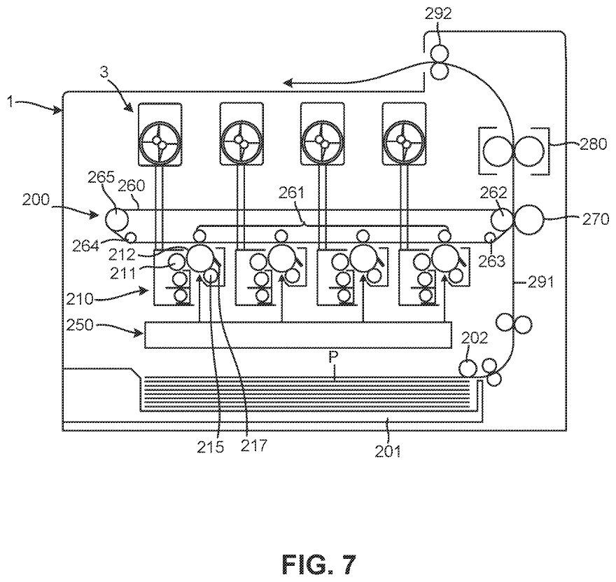

FIG. 7 is a schematic structural diagram of a print apparatus according to an example.

### DETAILED DESCRIPTION

Hereinafter, various examples will be described with reference to the drawings. However, the present disclosure may be implemented in several different forms and is not limited to the examples described hereinafter.

A print apparatus using an electrophotographic method may include a developing device to supply toner to an electrostatic latent image formed on a photoconductor for development as a visible toner image. The toner may be contained in a replaceable toner cartridge. A toner outlet may be provided in the toner cartridge. The toner may be discharged from the toner cartridge through the toner outlet and supplied to the developing device. The toner outlet is to stably supply toner from the toner cartridge to the developing device. For example, the toner outlet is to minimize the amount of toner remaining in the toner cartridge at termination of the lifetime of the toner cartridge.

According to various examples of the disclosure, a toner cartridge may include a body to contain toner and may include a toner outlet as well as a toner transport member that is installed inside the body to transport toner to the toner outlet by being rotated. The toner transport member may include a rotating spiral structure. The toner outlet may be arranged in a gravity direction side of the toner transport member and may be positioned to be biased toward a downstream side in a rotational direction of the toner transport member with respect to a reference line in a gravity direction passing through a rotation center of the toner transport member. The reference line may be a vertical line drawn from the rotation center of the toner transport member. For example, the toner outlet may have an upstream end portion and a downstream end portion in the rotation direction of the toner transport member. The reference line may pass through the toner outlet. In this case, a distance from the reference line to the downstream end portion may be greater than a distance from the reference line to the upstream end portion. In a region adjacent to the toner outlet inside the body, a level of toner may be higher in a downstream side than in an upstream side with respect to the reference line. Based on the toner outlet being positioned to be biased toward the downstream side, toner in the downstream side with a higher level than in the upstream side may be stably discharged to the toner outlet. Moreover, the amount of toner remaining in the toner cartridge may be minimized, thereby improving the use efficiency of toner of the toner cartridge.

In an example, the body may include a fixing unit provided with the toner outlet and a rotation unit to be coupled to the fixing unit so as to be rotated and contain toner. The toner transport member may include a spiral portion that protrudes from an inner circumferential surface of the rotation unit to transport toner in the rotation unit to the toner outlet in response to rotation of the rotation unit. In an example, the rotation unit may function as the toner transport member. An example of the toner cartridge may include a stirring member to stir toner in the fixing unit. The stirring member may be rotated in connection with the rotation unit. The stirring member may address agglomeration of toner near the toner outlet in the fixing unit and guide toner to the toner outlet. Thus, toner discharge performance may be improved.

The toner transport member may have various structures. For example, the toner transport member may be installed in the body in such a way as to be rotated. For example, the toner transport member may include a spiral coil. For example, the toner transport member may include an auger including a spiral wing.

For example, the body may include a toner container to contain toner and a toner discharge unit positioned in parallel with the toner container and provided with the toner outlet. The toner transport member may include the auger positioned in the toner discharge unit to transport toner to the toner outlet by being rotated. In the toner container, a toner transport paddle may be installed to supply toner to the toner discharge unit by transporting toner in a radial direction.

A toner cartridge according to an example of the disclosure may include a body provided with a toner outlet and a toner transport member including a rotating spiral structure installed inside the body to transport toner to the toner outlet by being rotated. The toner outlet may be positioned under a center of rotation of the toner transport member in such a way as to be biased toward the downstream side in the rotation direction of the toner transport member. For example, the toner outlet may have an upstream end portion and a downstream end portion in the rotation direction of the toner transport member. A vertical line drawn from the rotation center of the toner transport member may pass through the toner outlet. A distance from the downstream end portion of the toner outlet from the vertical line may be greater than a distance from the vertical line to the upstream end portion of the toner outlet. For example, the body may include a fixing unit provided with the toner outlet and a rotation unit coupled to the fixing unit so as to be rotated and contain toner. The toner transport member may include a spiral portion that protrudes from the inner circumferential surface of the rotation unit to transport toner in the rotation unit to the toner outlet. An example of the toner cartridge may further include a stirring member to be rotated in connection with the rotation unit to stir toner inside the fixing unit. For example, the toner transport member may include a spiral coil. For example, the body may include a toner container to contain toner and a toner discharge unit positioned in parallel with the toner container and provided with the toner outlet. The toner transport member may include the auger positioned in the toner discharge unit in such a way as to be rotated to transport toner to the toner outlet.

A print apparatus according to an example of the disclosure may include a developing device to develop an electrostatic latent image formed on a photoconductor by supplying toner to the electrostatic latent image and the above-described toner cartridge that contains toner to be supplied to the developing device. Hereinbelow, examples of the toner cartridge and the print apparatus employing the toner cartridge will be described with reference to the drawings. In the drawings, like reference numerals denote like components, and sizes of components may be exaggerated for clarity and convenience of explanation.

FIG. 1 is a schematic partial cross-sectional view of a toner cartridge 2 according to an example. FIG. 2 is a cross-sectional view taken along X1-X1′ of FIG. 1 according to an example. Referring to FIGS. 1 and 2, an example of the toner cartridge 2 may include a body 100 provided with a toner outlet 101 and a toner transport member 130 installed inside the body 100 to transport toner contained inside the body 100 to the toner outlet 101 by being rotated. The toner transport member 130 may include a rotating spiral structure. The toner outlet 101 may be positioned in a gravity direction side of the toner transport member 130. That is, the toner outlet 101 may be positioned under a rotation center CP of the toner transport member 130. The toner outlet 101 may be positioned to be biased toward the downstream side in a rotation direction RD of the toner transport member 130 with respect to a reference line RV in the gravity direction passing through the rotation center CP of the toner transport member 130. The reference line RV may be a vertical line drawn from the rotation center CP of the toner transport member 130.

The body 100 may have a hollow cylindrical shape. A cross-sectional shape of the body 100 is not limited and may be any shape capable of containing toner. The toner cartridge 2 may slide in a longitudinal direction L in such a way as to be mounted on or removed from a main body of a print apparatus, and the toner cartridge 2 may have a cross-sectional shape that is suitable to slide in the longitudinal direction L and to be mounted on or removed from the body of the print apparatus. The toner outlet 101 may be positioned adjacent to an end portion in the longitudinal direction L of the body 100. An example of the toner cartridge 2 may further include a shutter (not shown) to selectively open or close the toner outlet 101. For example, the shutter positioned in a position for closing the toner outlet 101 may be moved to a position for opening the toner outlet 101 based on the toner cartridge 2 being mounted on the main body of the print apparatus. In another example, based on the toner cartridge 2 being mounted on the main body of the print apparatus, the shutter may be moved to the position for opening the toner outlet 101 by a driving device (not shown) provided on the main body of the print apparatus.

The toner transport member 130 may be arranged inside the body 100. The toner transport member 130 may have a form suitable to transport toner to the toner outlet 101 by being rotated. A rotation central axis RX of the toner transport member 130 may extend along the toner cartridge 2, e.g., in the longitudinal direction L of the body 100. The toner transport member 130 may transport toner inside the body 100 toward the toner outlet 101 in the longitudinal direction L by being rotated in the rotation direction RD. The toner transport member 130 may include a rotating spiral structure having a pitch in the longitudinal direction L. The rotating spiral structure may be implemented in various forms. For example, the rotating spiral structure may be directly formed on the body 100 as described below, and may be implemented in the form of a spiral coil, an auger, etc. Various example forms of the toner transport member 130 will be described below.

In an example of the toner cartridge 2, the toner outlet 101 may be positioned in the gravity direction side of the toner transport member 130 and may be positioned to be biased toward the downstream side in the rotation direction RD of the toner transport member 130. That is, the toner outlet 101 may be positioned under the rotation center CP of the toner transport member 130 and may be positioned to be biased toward the downstream side in the rotation direction RD of the toner transport member 130. For example, the toner outlet 101 may include an upstream end portion 101U and a downstream end portion 101D with respect to the reference line RV passing through the rotation center CP of the toner transport member 130, i.e., a vertical line drawn from the rotation center CP of the toner transport member 130. The reference line RV may pass through the toner outlet 101. A distance DD from the reference line RV to the downstream end portion 101D may be greater than a distance DU from the reference line RV to the upstream end portion 101U.

Referring to FIG. 1, based on toner being transported by the toner transport member 130 having a spiral portion 122 in the longitudinal direction L, toner may be transported in a direction indicated by arrows AA. This is because the spiral portion 122 of the toner transport member 130 is inclined with respect to the rotation center axis RX and a transport direction AA is orthogonal to the spiral portion 122. Thus, the level of toner near the toner outlet 101 may be higher in the downstream side than in the upstream side in the rotation direction RD with respect to the reference line RV, as shown in FIG. 2. That is, toner may be distributed to be biased toward the downstream side in the rotation direction RD with respect to the reference line RV.

In a situation in which the toner outlet 101 is positioned symmetrically to the reference line RV, that is, in a situation in which the distance DU and the distance DD are equal to each other, the toner outlet 101 may not be positioned to receive a maximum downward pressure due to distribution of toner, thus degrading toner discharge performance. The distribution of toner leaning to the downstream side in the rotation direction RD of the toner transport member 130 is maintained up to a last period of the lifetime of the toner cartridge 2, and in this case, the level of toner is low such that the discharge pressure is low due to a self-weight of the toner, further degrading toner discharge performance. In that case, the amount of toner discharged per unit time decreases, and a driving amount and a driving time of the toner transport member 130 may be increased until the toner in the body 100 is entirely discharged. Based on the amount of toner discharged during a certain driving time failing to reach a reference amount, it may be identified that the toner inside the toner cartridge 2 is entirely used. In this case, an amount of toner may remain to some extent inside the toner cartridge 2. Based on toner inside the toner cartridge 2 being used, the toner cartridge 2 may be removed from the main body of the print apparatus and a new toner cartridge 2 may be mounted on the main body of the print apparatus. The toner remaining in the removed toner cartridge 2 may be discarded together with the toner cartridge 2. Degradation of toner discharge performance may increase the amount of remaining toner that is discarded without being used. Based on the toner outlet 101 being positioned to be biased toward the upstream side with reference to the reference line RV, that is, the distance DU is greater than the distance DD, the amount of remaining toner that is discarded without being used may become worse.

According to various examples of the toner cartridge 2, a position of the toner outlet 101 is biased toward the downstream side in the rotation direction RD of the toner transport member 130 with respect to the rotation center CP or the reference line RV. The toner distributed to be biased toward the downstream side in the rotation direction RD may be stably discharged through the toner outlet 101 positioned to be biased toward the downstream side in the rotation direction RD by the self-weight of the toner, thus improving toner discharge performance. The improved toner discharge performance may be maintained throughout the lifetime of the toner cartridge 2 and the use efficiency of the toner contained in the toner cartridge 2 may be increased. The amount of remaining toner discarded without being used in a print job may be reduced, thus increasing a replacement period of the toner cartridge 2 that is a consumable, which helps to reduce the cost of consumables.

Referring to FIGS. 1 and 2, the body 100 may include a fixing unit 110 provided with the toner outlet 101 and a rotation unit 120 coupled to the fixing unit 110 so as to be rotated and contain toner. The toner transport member 130 having a rotating spiral structure may include a spiral portion 122. The spiral portion 122 may protrude from an inner circumferential surface 121 of the rotation unit 120 to transport toner in the rotation unit 120 to the toner outlet 101. The toner outlet 101 may be provided in the fixing unit 110. The fixing unit 110 may have, for example, a tub shape having an opened side. The shutter (not shown) for opening and closing the toner outlet 101 may be provided in the fixing unit 110. Toner may be contained inside the rotation unit 120. The rotation unit 120 may be coupled to the fixing unit 110 so as to rotate. For example, the rotation unit 120 may have a tub shape, e.g., a cylindrical shape, which has an opened side. An opened end portion of the rotation unit 120 may be coupled to an opened end portion of the fixing unit 110 so as to rotate. The rotation unit 120 may transport toner contained therein to the fixing unit 110 by being rotated about the rotation center axis RX. The rotation center axis RX may be an axis extending in the longitudinal direction L of the rotation unit 120. The toner transport member 130 may be implemented by the spiral portion 122 formed to protrude from the inner circumferential surface 121 along an outer circumference of the rotation unit 120. In response to rotation of the rotation unit 120, toner inside the rotation unit 120 may be transported to the fixing unit 110 by the spiral portion 122.

The rotation unit 120 may be rotated by receiving a rotation power from the main body of the print apparatus in a situation in which the toner cartridge 2 is mounted on the main body of the print apparatus. FIG. 3 is a schematic perspective view of a structure to rotate the rotation unit 120 of the toner cartridge 2 according to an example. Referring to FIG. 3, the rotation unit 120 may include a coupler 150. The coupler 150 may be provided in an end portion in the longitudinal direction L of the rotation unit 120, e.g., an opposite end portion of the fixing unit 110. Based on the toner cartridge 2 being mounted on a main body 1 of the print apparatus, the fixing unit 110 may be nested in a mounting position by a position determining device (not shown) provided inside the main body 1 of the print apparatus. In this case, the coupler 150 may be engaged with a driving coupler 12 provided in the main body 1. The coupler 150 and the driving coupler 12 may have complementary shapes to engage with each other to transfer a rotation power. By driving a driving motor 11 to rotate the driving coupler 12, the rotation unit 120 may be rotated with respect to the fixing unit 110.

With this example structure, the rotation unit 120 and the toner transport member 130 may be formed integrally such that installation of a separate toner transport member to transport toner in the rotation unit 120 to the toner outlet 101 in the rotation unit 120 may be avoided. Thus, the toner cartridge 2 may be manufactured with low cost and the cost of the toner cartridge 2 that is a consumable may be reduced for a user.

A structure for rotating the rotation unit 120 is not limited to the above-described example. Although not shown, a driving gear (not shown) may be provided on the main body 1. A driven gear (not shown) to engage with a driving gear may be provided in the rotation unit 120. Based on the toner cartridge 2 being mounted on the main body 1, the driving gear and the driven gear may be engaged with each other. The rotation power of the driving motor 11 may be transported to the rotation unit 120 through the driving gear and the driven gear such that the rotation unit 120 may be rotated.

Referring again to FIG. 2, an example of the toner cartridge 2 may further include a stirring member 140. The stirring member 140 may stir toner in the fixing unit 110. The stirring member 140 may include a stirring unit 141 having a length in a radial direction. The stirring member 140 may be located adjacent to the toner outlet 101 in the longitudinal direction L. The stirring unit 141 may be located close to the toner outlet 101 in the radial direction. The stirring member 140 may be rotated. For example, the stirring member 140 may be rotated around a common rotation center axis with the toner transport member 130, e.g., the rotation center axis RX of the toner transport member 130. For example, the stirring member 140 may be rotated in the same direction as the toner transport member 130. For example, the stirring member 140 may be rotated in connection with the rotation unit 120. For example, the stirring member 140 may be coupled to an opened end portion of the rotation unit 120 or a vicinity thereof. For example, the stirring member 140 may be formed integrally with the rotation unit 120. With this structure, a separate driving member to rotate the stirring member 140 may be omitted.

Toner transported by the toner transport member 130 may be accumulated near the toner outlet 101. The accumulated toner may form a toner pressure. As the toner pressure near the toner outlet 101 increases, agglomeration of the toner may occur. Agglomeration of the toner may degrade fluidity of the toner around the toner outlet 101. The stirring member 140 may address agglomeration of the toner by stirring the toner near the toner outlet 101. As such, the fluidity of the toner near the toner outlet 101 may be increased and the toner discharge performance may be improved.

The toner outlet 101 positioned to be biased toward the downstream side in the rotation direction RD with respect to the rotation center CP of the toner transport member 130 or the reference line RV may be associated with the stirring member 140. As the stirring member 140 is rotated in the same direction as the toner transport member 130, the stirring member 140, together with the toner transport member 130, may form a distribution of toner leaning to the downstream side in the rotation direction RD in the fixing unit 110. Thus, the toner outlet 101 leaning to the downstream side may improve toner discharge performance in the toner cartridge 2 employing the stirring member 140.

The stirring member 140 may apply pressure to toner inside the toner outlet 101 in a process of stirring toner near the toner outlet 101. For example, referring to FIG. 2, the toner stirred by rotation of the stirring member 140 may be transported into the toner outlet 101 from the upstream end portion 101U of the toner outlet 101. In this case, a force F1 may be applied to toner inside the toner outlet 101. The direction of the force F1 may be a direction of a tangent line at the upstream end portion 101U of the toner outlet 101. Toner inside the toner outlet 101 may be firmed by a component of the force F1 in the gravity direction, resulting in toner agglomeration. By reducing the component of the force F1 in the gravity direction, toner agglomeration inside the toner outlet 101 may be reduced or prevented. To this end, the upstream end portion 101U of the toner outlet 101 may be located as close to the reference line RV as possible. For example, based on the upstream end portion 101U being far from the reference line RV, a force F2 may be applied to toner inside the toner outlet 101 by the stirring member 140 as indicated by a dotted line in FIG. 2. A component of the force F2 in the gravity direction is greater than the component of the force F1 in the gravity direction.

According to an example of the toner cartridge 2, the toner outlet 101 may be positioned toward the downstream side in the rotation direction RD with respect to the rotation center CP of the toner outlet 101 or the reference line RV. That is, the upstream end portion 101U of the toner outlet 101 may be positioned relatively close to the reference line RV. Thus, the component of the force applied by the stirring member 140 to the toner outlet 101 in the gravity direction may be reduced, and agglomeration of toner inside the toner outlet 101 and corresponding degradation of the toner discharge performance may be reduced or prevented.

As such, according to an example of the toner cartridge 2, by positioning the toner outlet 101 asymmetrically to the reference line RV based on the distribution of toner inside the fixing unit 110, toner may be stably discharged to the toner outlet 101 by the self-weight of the toner. By adopting the stirring member 140, toner agglomeration near the toner outlet 101 may be reduced or prevented, thereby maintaining stable toner discharge performance during the lifetime of the toner cartridge 2. By reducing a pressure applied to the toner in the toner outlet 101 by the stirring member 140, agglomeration of toner inside the toner outlet 101 may be reduced or prevented.

FIG. 4 is a schematic cross-sectional view of a toner cartridge 2a according to an example. FIG. 4 corresponds to a cross-sectional view taken along X1-X1′ of FIG. 1. The toner cartridge 2a of the current example is different from the example of the toner cartridge 2 shown in FIGS. 1 to 3 in that the toner cartridge 2a includes an integral body 100A and employs a spiral coil 130a instead of the toner transport member 130 having the spiral portion 122. A difference will be mainly described below. Referring to FIG. 4, toner may be contained inside the body 100A. The toner outlet 101 may be provided around an end portion of the body 100A in the longitudinal direction L.

The toner transport member may include the spiral coil 130a. The spiral coil 130a may be arranged inside the body 100A. The spiral coil 130a may extend in the longitudinal direction L. An end portion of the spiral coil 130a may be exposed outside through an end portion of the body 100A in the longitudinal direction L, e.g., an opposite end portion of the toner outlet 101. A coupler (not shown) may be connected to the exposed end portion of the spiral coil 130a. Based on the toner cartridge 2a being mounted on the main body 1 of the print apparatus (see FIG. 3), the coupler may be engaged with the driving coupler 12 described with reference to FIG. 3. By rotating the driving motor 11, the spiral coil 130a may be rotated. Toner contained inside the body 100 may be transported by rotation of the spiral coil 130a in the longitudinal direction L and may be supplied to the toner outlet 101.

Each spiral portion 132a of the spiral coil 130a may be inclined with respect to the rotation center axis RX and the transport direction AA (see FIG. 1) of toner by the spiral coil 130a may be orthogonal to the spiral portion 132a. Thus, the level of toner near the toner outlet 101 may be higher in the downstream side than in the upstream side in the rotation direction RD with respect to the rotation center CP or the reference line RV, as shown in FIG. 4. That is, toner may be distributed leaning toward the downstream side in the rotation direction RD with respect to the reference line RV. In this regard, a position of the toner outlet 101 may be biased toward the downstream side in the rotation direction RD of the spiral coil 130a under (in the gravity direction) the rotation center CP of the spiral coil 130a. For example, the toner outlet 101 may include the upstream end portion 101U and the downstream end portion 101D with respect to the reference line (vertical line) RV passing through the rotation center CP of the spiral coil 130a. The reference line RV may pass through the toner outlet 101. The distance DD from the reference line RV to the downstream end portion 101D may be greater than the distance DU from the reference line RV to the upstream end portion 101U.

FIG. 5 is a schematic cross-sectional view of a toner cartridge 2b according to an example. FIG. 5 corresponds to a cross-sectional view taken along X1-X1′ of FIG. 1. The toner cartridge 2b of the current example is different from the example of the toner cartridge 2 shown in FIGS. 1 to 3 in that the toner cartridge 2b includes an integral body 100B and employs an auger 130b having a spiral wing 132b instead of the toner transport member 130 having the spiral portion 122. A difference will be mainly described below. Referring to FIG. 5, toner may be contained inside the body 100B. The toner outlet 101 may be provided around an end portion of the body 100B in the longitudinal direction L.

The toner transport member may include the auger 130b. The auger 130b may be arranged inside the body 100B. The auger 130b may include a shaft 131b extending in the longitudinal direction L and the spiral wing (e.g., a spiral portion) 132b formed along the outer circumference of the shaft 131b. An end portion of the shaft 131b may be exposed outside through an end portion of the body 100B in the longitudinal direction L, e.g., the opposite end portion of the toner outlet 101. The coupler (not shown) may be connected to the exposed end portion of the shaft 131b. Based on the toner cartridge 2b being mounted on the main body 1 of the print apparatus (see FIG. 3), the coupler may be engaged with the driving coupler 12 described with reference to FIG. 3. By rotating the driving motor 11, the auger 130b may be rotated. Toner contained inside the body 100 may be transported by rotation of the auger 130b in the longitudinal direction L and may be supplied to the toner outlet 101.

The spiral wing 132b of the auger 130b may be inclined with respect to the rotation center axis RX and the transport direction AA (see FIG. 1) of toner by the auger 130b may be orthogonal to the spiral wing 132b. Thus, the level of toner near the toner outlet 101 may be higher in the downstream side than in the upstream side in the rotation direction RD with respect to the rotation center CP, as shown in FIG. 5. That is, toner may be distributed to be biased toward the downstream side in the rotation direction RD with respect to the rotation center CP or the reference line (i.e., vertical line) RV. In this regard, a position of the toner outlet 101 may be biased toward the downstream side in the rotation direction RD of the auger 130b under (in the gravity direction) the rotation center CP of the auger 130b. For example, the toner outlet 101 may include the upstream end portion 101U and the downstream end portion 101D with respect to the reference line RV. The reference line RV may pass through the toner outlet 101. The distance DD from the reference line RV to the downstream end portion 101D may be greater than the distance DU from the reference line RV to the upstream end portion 101U.

FIG. 6 is a schematic cross-sectional view of a toner cartridge 2c according to an example. FIG. 6 corresponds to a cross-sectional view taken along X1-X1′ of FIG. 1. The toner cartridge 2c of the current example may be different from the example of the toner cartridge 2 described with reference to FIGS. 1 to 3 in that a body 100C is divided into a toner container 160 and a toner discharge unit 170. A difference will be mainly described below. Referring to FIG. 6, the toner cartridge 2c may include the body 100C including the toner outlet 101. The body 100C may include the toner container 160 and the toner discharge unit 170.

The toner container 160 may extend in the longitudinal direction L. Toner may be contained inside the toner container 160. A toner transport paddle 161 may be arranged in the toner container 160. The toner transport paddle 161 may be arranged in the toner container 160 to transport toner in the radial direction by being rotated to supply toner to the toner discharge unit 170. For example, the toner transport paddle 161 may include a shaft 161a extending in the longitudinal direction L and an elastic transport wing 161b installed on an outer circumference of the shaft 161a and having a length in the radial direction.

The toner discharge unit 170 may extend in the longitudinal direction L in parallel with the toner container 160. The toner outlet 101 may be provided in the toner discharge unit 170. The toner outlet 101 may be provided near an end portion of the toner discharge unit 170 in the longitudinal direction L. The toner discharge unit 170 may communicate with the toner container 160 in the radial direction. In the toner discharge unit 170, a toner transport member may be arranged to transport toner in the longitudinal direction L to supply toner to the toner outlet 101. The toner transport member may include an auger 130c positioned in the toner discharge unit 170 to transport toner to the toner outlet 101 by being rotated. The auger 130c may include a shaft 131c extending in the longitudinal direction L and a spiral wing 132c formed along the outer circumference of the shaft 131c.

For example, an end portion of the shaft 161a of the toner transport paddle 161 may be exposed outside through an end portion of the toner container 160 in the longitudinal direction L, e.g., the opposite end portion of the toner outlet 101. A coupler (not shown) may be connected to the exposed end portion of the shaft 161a. An end portion of the shaft 131c of the auger 130c may be exposed outside through an end portion of the toner discharge unit 170 in the longitudinal direction L, e.g., the opposite end portion of the toner outlet 101. A power delivery member, e.g., a gear (not shown) may be connected to the exposed end portion of the shaft 131c. The gear may be connected to the coupler (not shown) by the power delivery member (not shown), e.g., another gear. Based on the toner cartridge 2c being mounted on the main body 1 of the print apparatus (see FIG. 3), the coupler (not shown) may be engaged with the driving coupler 12 described with reference to FIG. 3. By rotating the coupler (not shown) by rotation of the driving motor 11, the toner transport paddle 161 and the auger 130c may be rotated. Toner supplied from the toner container 160 to the toner discharge unit 170 by the toner transport paddle 161 may be transported to the toner outlet 101 by the auger 130c.

In the toner discharge unit 170, the spiral wing 132c of the auger 130c may be inclined with respect to the rotation center axis RX, and the transport direction AA (see FIG. 1) of toner by the auger 130c may be orthogonal to the spiral wing 132c. Thus, the level of toner near the toner outlet 101 may be higher in the downstream side than in the upstream side in the rotation direction RD with respect to the rotation center CP or the reference line (vertical line) RV, as shown in FIG. 6. That is, toner may be distributed to be biased toward the downstream side in the rotation direction RD with respect to the rotation center CP, i.e., the reference line RV. In this regard, a position of the toner outlet 101 may be biased toward the downstream side in the rotation direction RD of the auger 130c under (in the gravity direction) the rotation center CP of the auger 130c. For example, the toner outlet 101 may include the upstream end portion 101U and the downstream end portion 101D with respect to the reference line RV. The reference line RV may pass through the toner outlet 101. The distance DD from the reference line RV to the downstream end portion 101D may be greater than the distance DU from the reference line RV to the upstream end portion 101U.

FIG. 7 is a schematic structural diagram of a print apparatus according to an example. Referring to FIG. 7, the print apparatus may include a main body 1 including a print unit 200 to supply toner to an electrostatic latent image formed on a photoconductor, e.g., a photoconductive drum 212 for development, and a toner cartridge 3 in which toner to be supplied to the print unit 200 may be contained. The print unit 200 may print an image on a print medium P by an electrophotographic method. The print unit 200 of the current example may print a color image on the print medium P by an electrophotographic method.

The print unit 200 may include a plurality of developing devices 210, an exposer 250, an intermediate transfer belt 260, a transfer roller 270, and a fuser 280. The plurality of developing devices 210 may include four developing devices 210 to form a toner image in colors of yellow (Y), magenta (M), cyan (C), and black (K), respectively. In the four developing devices 210, developers in colors of C, M, Y, and K, e.g., toners and carriers may be respectively contained. In four toner cartridges 3, the toner in colors of C, M, Y, and K may be respectively contained. Toners in colors of Y, M, C, and K may be respectively supplied to the four developing devices 210 from the four toner cartridges 3. The developing device 210 may include the photoconductive drum 212 on a surface of which the electrostatic latent image may be formed, and a development roller 211. The developing device 210 may develop the electrostatic latent image into a visible toner image by supplying toner to the electrostatic latent image.

A charging roller 215 may charge the photoconductive drum 212 to have a uniform surface electric potential. The exposer 250 may irradiate light modulated corresponding to image information to the photoconductive drum 212 to form an electrostatic latent image on the photoconductive drum 212. The development roller 211 may supply the toner contained in the developing device 210 to a development region opposing the photoconductive drum 212. The toner may be supplied to the electrostatic latent image across the development region by a developing bias voltage applied to the development roller 211, such that the electrostatic latent image may be developed into the visible toner image. The intermediate transfer belt 260 may be circularly driven by being supported by a plurality of support rollers 262, 263, 264, and 265. Four intermediate transfer rollers 261 may be arranged at positions facing the photoconductive drum 212 of the four developing devices 210 with the intermediate transfer belt 260 therebetween. The toner image developed on the photoconductive drum 212 may be intermediately transferred to the intermediate transfer belt 260 by an intermediate transfer bias voltage applied to the intermediate transfer roller 261. A cleaning member 217 may remove developer remaining on the surface of the photoconductive drum 212 after an intermediate transfer process. The transfer roller 270 may be located facing the intermediate transfer belt 260 to form a transfer nip. The print medium P may be picked up by a pickup roller 202 from a feeding cassette 201 and fed to the transfer nip along a path 291. By the transfer bias voltage applied to the transfer roller 270, the toner image on the intermediate transfer belt 260 may be transferred to the print medium P. The fuser 280 may fuse the toner image transferred to the print medium P onto the print medium P by applying heat and pressure to the toner image. The print medium P on which printing is completed may be discharged by a discharge roller 292.

As the toner cartridge 3, the above-described toner cartridges 2, 2a, 2b, and 2c may be applied. The toner cartridge 3 may be connected to the developing device 210 and supply toner to the developing device 210 based on toner inside the developing device 210 being used up. For example, a sensor to detect an amount of remaining toner may be provided inside the developing device 210. Based on the amount of remaining toner detected by the sensor being less than or equal to a reference remaining amount, a controller (not shown) may drive the toner cartridge 3 to supply toner to the developing device 210. For example, the controller may drive the driving motor 11 (see FIG. 1) to rotate the rotation unit 120 formed integrally with the toner transport member 130, to rotate the spiral coil 130a or the auger 130b inside the bodies 100A and 100B, or to rotate the toner transport paddle 161 and the auger 130c inside the toner container 160 and the toner discharge unit 170.

Toner inside the rotation unit 120, or the bodies 100A and 100B, or the toner container 160 and the toner discharge unit 170 may be transported to the toner outlet 101 by a rotating spiral structure. Toner may be discharged through the toner outlet 101 and supplied to the developing device 210. The amount of toner discharged from the toner cartridge 3 may depend on the amount of rotation or a rotation time of the rotation unit 120, the spiral coil 130a, the auger 130b, or the auger 130c. Toner may be distributed such that a downstream side in the rotation direction RD has a higher level than an upstream side near the toner outlet 101. As a position of the toner outlet 101 is biased toward the downstream with respect to the rotation center CP or the reference line RV, toner discharge performance may be improved. Moreover, an amount of remaining toner to be discarded without being effectively used for printing, out of the toner contained in the toner cartridge 3, may be minimized.

It should be understood that examples described herein should be considered in a descriptive sense and not for purposes of limitation. Descriptions of features or aspects within each example should typically be considered as available for other similar features or aspects in other examples. While examples have been described with reference to the figures, it will be understood that various changes in form and details may be made therein without departing from the spirit and scope as defined by the following claims,

1. A toner cartridge comprising:
a body including a toner outlet;
a toner transport member, having a rotating spiral structure, located inside the body to transport toner to the toner outlet by being rotated,
wherein the toner outlet is located in a gravity direction side of the toner transport member, and
wherein a position of the toner outlet is biased toward a downstream side in a rotation direction of the toner transport member with respect to a reference line in a gravity direction passing through a rotation center of the toner transport member.

2. The toner cartridge of claim 1,
wherein the toner outlet comprises an upstream end portion and a downstream end portion in the rotation direction of the toner transport member,
wherein the reference line passes through the toner outlet, and
wherein a distance from the reference line to the downstream end portion is greater than a distance from the reference line to the upstream end portion.

3. The toner cartridge of claim 1,
wherein the body comprises a fixing unit including the toner outlet and a rotation unit coupled to the fixing unit to be rotated and to contain toner, and
wherein the toner transport member comprises a spiral portion protruding from an inner circumferential surface of the rotation unit to transport toner in the rotation unit to the toner outlet.

4. The toner cartridge of claim 3, further comprising a stirring member to stir toner in the fixing unit.

5. The toner cartridge of claim 4, wherein the stirring member is to be rotated in connection with the rotation unit.

6. The toner cartridge of claim 1, wherein the toner transport member comprises a spiral coil.

7. The toner cartridge of claim 1, wherein the toner transport member comprises an auger comprising a spiral wing.

8. The toner cartridge of claim 1,
wherein the body comprises a toner container to contain toner and a toner discharge unit positioned in parallel with the toner container and provided with the toner outlet, and
wherein the toner transport member comprises an auger positioned in the toner discharge unit to transport toner to the toner outlet by being rotated.

9. The toner cartridge of claim 8, further comprising a toner transport paddle arranged in the toner container to transport toner in a radial direction by being rotated to supply toner to the toner discharge unit.

10. A toner cartridge comprising:
a body including a toner outlet; and
a toner transport member, having a rotating spiral structure, located inside the body to transport toner to the toner outlet by being rotated,
wherein the toner outlet is located under a rotation center of the toner transport member such that the toner outlet is biased toward a downstream side in a rotation direction of the toner transport member.

11. The toner cartridge of claim 10,
wherein the toner outlet comprises an upstream end portion and a downstream end portion in the rotation direction of the toner transport member,
wherein a vertical line drawn from the rotation center of the toner transport member passes through the toner outlet, and
wherein a distance from the vertical line to the downstream end portion is greater than a distance from the vertical line to the upstream end portion.

12. The toner cartridge of claim 10,
wherein the body comprises a fixing unit provided with the toner outlet and a rotation unit coupled to the fixing unit to be rotated and to contain toner, and
wherein the toner transport member comprises a spiral portion protruding from an inner circumferential surface of the rotation unit to transport toner in the rotation unit to the toner outlet.

13. The toner cartridge of claim 12, further comprising a stirring member to stir toner in the fixing unit by being rotated in connection with the rotation unit.

14. The toner cartridge of claim 10, wherein the toner transport member comprises a spiral coil.

15. A print apparatus comprising:
a developing device to supply toner to an electrostatic latent image formed on a photoconductor and to develop the electrostatic latent image; and
a toner cartridge to contain toner to be supplied to the developing device,
wherein the toner cartridge comprises:
a body provided with a toner outlet; and
a toner transport member, having a rotating spiral structure, located inside the body to transport toner to the toner outlet by being rotated,
wherein the toner outlet is arranged at a gravity direction side of the toner transport member, and
wherein a position of the toner outlet is biased toward a downstream side in a rotation direction of the toner transport member with respect to a reference line in a gravity direction passing through a rotation center of the toner transport member.
